(19) United States
(12) Patent Application Publication
(10) Pub. No.: US 2025/0347154 A1
(43) Pub. Date: Nov. 13, 2025

(54) SMART BIKE LOCK

(71) Applicant: Green Spirit Technologies Inc., North Vancouver (CA)

(72) Inventors: Robert Adamovsky, North Vancouver (CA); Sy Haw WONG, North Vancouver (CA); Xinghao LI, North Vancouver (CA); Koosha REZAIEZADEH, North Vancouver (CA); Nadeem JAMAL, North Vancouver (CA)

(21) Appl. No.: 19/207,198

(22) Filed: May 13, 2025

Related U.S. Application Data
(60) Provisional application No. 63/646,268, filed on May 13, 2024.

(51) Int. Cl. E05B 71/00; B62H 5/14; B62H 5/20

(52) U.S. Cl. CPC E05B 71/00; B62H 5/141; B62H 5/20

(57) ABSTRACT

Embodiments of the present disclosure relate to devices for locking a bicycle to a station. The lock can be arranged to slide, rotate and pivot. It includes a lock body and locking arm that swings open to allow a portion of a bicycle within a lock area. A lock latch secures the locking arm to the lock body when the lock arm is closed to secure the bike. Electronics within the bike lock allows for automated locking and unlocking as well as sensors that detect theft. The bike lock can communicate with the user via a mobile app.

### FIELD OF THE INVENTION

The present disclosure relates generally to bicycles, in particular devices and systems for locking them.

### BACKGROUND OF THE INVENTION

Bicycles are an increasingly popular mode of transportation due to their affordability, environmental benefits, and health advantages. However, bike theft remains a major concern, prompting the widespread use of bicycle locks to secure bikes in public spaces. Despite various designs and security mechanisms, conventional bike locks suffer from several shortcomings that leave bicycles vulnerable to theft.

One common issue with existing bike locks is their susceptibility to physical attacks. Many locks, including cable and chain locks, can be easily cut using bolt cutters or angle grinders. Even heavy-duty U-locks, considered more secure, can sometimes be defeated with leverage attacks or hydraulic jacks, allowing thieves to break the lock without requiring sophisticated tools.

Furthermore, traditional bike locks often lack smart security features. In an age where connected devices are increasingly integrated into daily life, most locks do not offer real-time tracking, remote locking capabilities, or theft alerts. If a bicycle is stolen, there is typically no way to trace its location, making recovery nearly impossible.

Given these limitations, there is a clear need for an improved bike lock design that offers enhanced security, user convenience, and modern technology integration. The present invention addresses these concerns by introducing an innovative solution that significantly reduces the risk of theft while improving the overall user experience.

### SUMMARY OF THE INVENTION

To address the shortcomings of the current devices, a new device and system is provided that has these advantages and solves certain problems mentioned above.

In one general aspect, a bike lock includes a bike lock body; a bike lock clamp fixable to public infrastructure and arranged to slide, rotate, or pivot thereto; a locking arm connected to the bike lock body and moveable thereto to receive a bike frame or wheel in an unlocked configuration; a lock latch that secures the locking arm to the bike lock body in a locked configuration, where the bike frame or wheel is secured; and an electronic circuit to receive a lock/unlock command from an user and relay a signal to lock the lock latch. Other embodiments of this aspect include corresponding computer systems, apparatus, and computer programs recorded on one or more computer storage devices, each configured to operate the bike lock and perform the actions of the methods.

Implementations may include one or more of the following features. The bike lock where the locking arm is connected to the bike lock body at a pivot point at an end of the locking arm opposite from the lock latch. Bike lock may include an anti-theft sensor, preferably located within the locking arm, more preferably as an alarm wire providing electrical continuity to and from the bike lock body, when the bike lock is in the locked configuration. Bike lock may include an actuator that moves the lock latch upon receiving the signal from the electronic circuit. Bike lock where the electronic circuit receives the lock/unlock command by at least one of: wireless communication, electronic buttons, a touchscreen, credit card reader, RFID reader, or an electronic keypad. Bike lock may include sensors to trigger an alarm and send wireless notifications. Implementations of the described techniques may include hardware, a method or process, or a computer tangible medium.

In one general aspect, a method may include fixing a bike lock clamp to public infrastructure; opening a locking arm connected to the bike lock body in an unlocked configuration and receiving a bike frame or wheel; closing the locking arm into a locked configuration to secure the bike frame or wheel; receiving a lock/unlock command from an user, at an electronic circuit within the bike lock; and relaying a signal to secure the locking arm to the bike lock body with a lock latch in the locked configuration. Other embodiments of this aspect include corresponding computer systems, apparatus, and computer programs recorded on one or more computer storage devices, each configured to perform the actions of the methods.

A system of processors can be configured to perform particular operations for a bike lock by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. The instructions may be stored in instruction memory of the bike locks, bike lock stations, and web/mobile applications and those devices.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Various objects, features and advantages of the invention will be apparent from the following description of embodiments of the invention, as illustrated in the accompanying drawings.

FIG. 1 is a side view of a smart bike lock.

FIG. 2 is a perspective view of the bike lock.

FIG. 3 is a perspective view of the bike lock in an open configuration.

FIG. 4 is the opposite side view of the bike lock of FIG. 1.

FIG. 5 is a front view of the bike lock.

FIG. 6A is a perspective view of the bike lock coupled to a bike lock station in a first configuration.

FIG. 6B is a side view of the bike lock coupled to a bike lock station in a second configuration.

FIG. 6C is a side view of the bike lock coupled to a bike lock station in a third configuration.

FIG. 7A is a cross-sectional view of the bike lock.

FIG. 7B is a perspective view of a locking arm with recess for receiving a latch.

FIG. 8A is a side view of a deadbolt.

FIG. 8B is a front view of the deadbolt.

FIG. 8C is a bottom view of the deadbolt.

FIG. 8D is a perspective view of the deadbolt.

FIG. 9A is a perspective view of a mount from a first angle.

FIG. 9B is a perspective view of the mount from a second angle.

FIG. 9C is a perspective view of the mount from a third angle.

FIG. 10 is a block diagram of a electronic circuit for controlling the bike lock.

In the drawings, the same reference numbers identify similar elements or acts. In the drawings, angle, size, and relative position of elements are not necessarily shown to scale. For example, some of these elements may be enlarged or positioned to improve drawing legibility. Further, the shapes of any elements as drawn, are not necessarily intended to convey any information regarding the actual shape of the particular elements and may have been solely selected for ease of illustration or recognition.

### DETAILED DESCRIPTION OF THE INVENTION

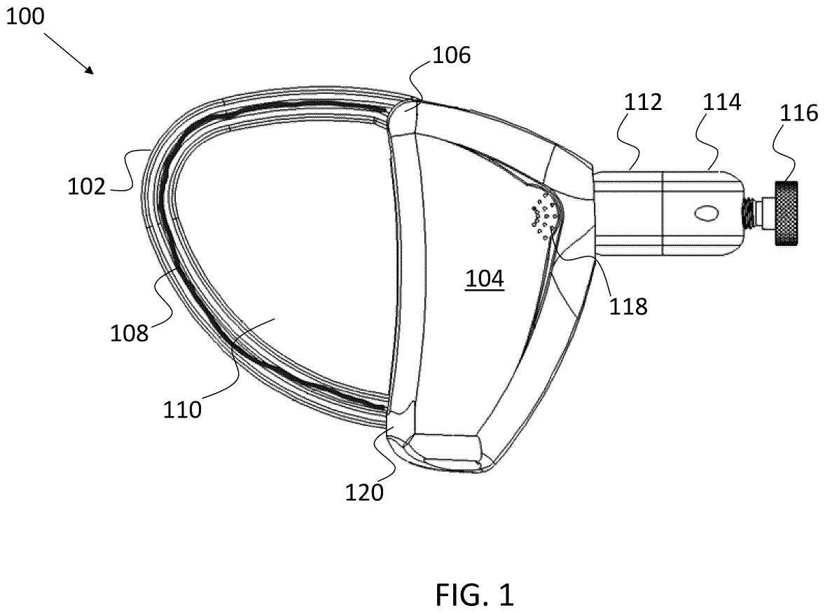

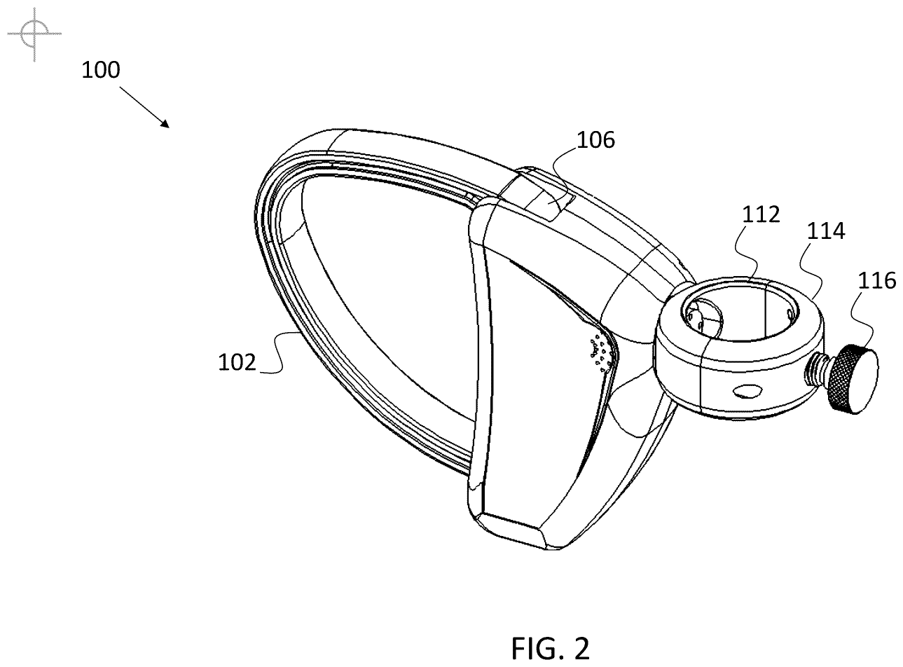

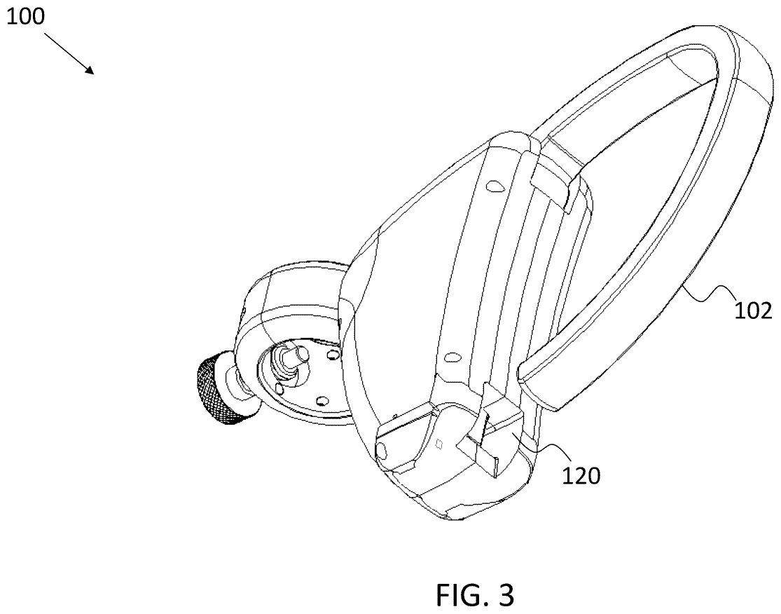

With reference to the accompanying figures, exemplary devices and methods are disclosed for a smart bike lock. As shown in FIG. 1, FIG. 2 and FIG. 3 bike lock 100 includes a locking arm/locking bar (i.e. lock arm 102) which is coupled to the body 104 at pivot point 106. The pivoting mechanism at pivot point 106 allows the lock arm 102 to swing out of the body 104 from the distal end of pivot point 106 (i.e. lock latch point 120) that defines a space to allow a portion of a bicycle to be coupled to the bike lock 100, the space is shown as lock area 110.

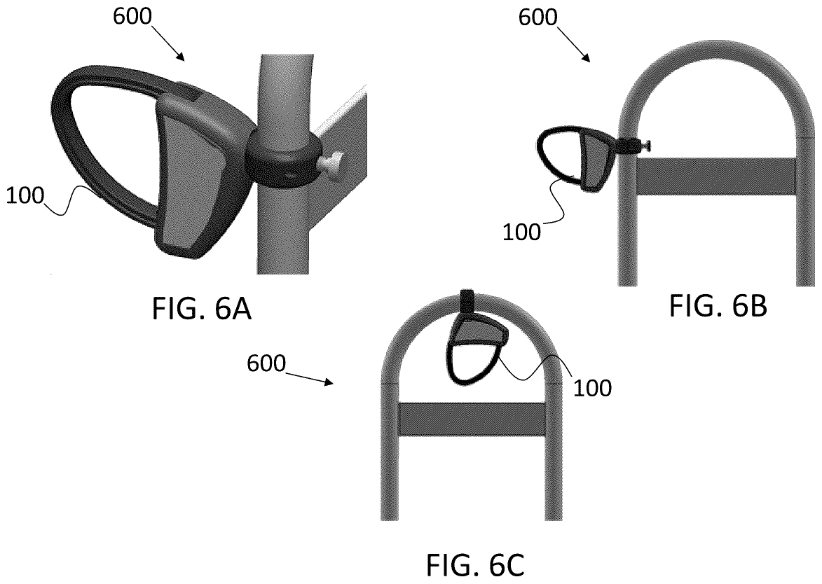

The body 104 of bike lock 100 is coupled to a locking infrastructure such as bike lock station 600 of FIG. 6A, FIG. 6B and FIG. 6C. In some embodiments, a fastener such as clamp 114 that can remain fixed onto bike lock station 600 can be utilized to couple bike lock 100 to the infrastructure. A person of skill in the art will appreciate that clamp 114 can include any shape, form or size suitable to accommodate a variety of shapes, forms and sizes of locking infrastructure. Furthermore, clamp 114 can be a unitary piece of fastener or it can include multiple parts.

Clamp 114 can be coupled to the bike lock station 600 via for example screws, adhesives or a combination thereof. In the preferred embodiment, a knob such as retractable spring knob 116 capable of supporting the mass of bike lock 100 is used to couple clamp 114 to the bike lock station 600. Conversely, the retractable spring knob 116 can be pulled on to allow the clamp 114, and therefore, the bike lock 100 to loosen from the bike lock station 600 to allow movement along the surface of the infrastructure. In some embodiments, retractable spring knob 116 can be a common screwing knob or a comparable product available in the marketplace.

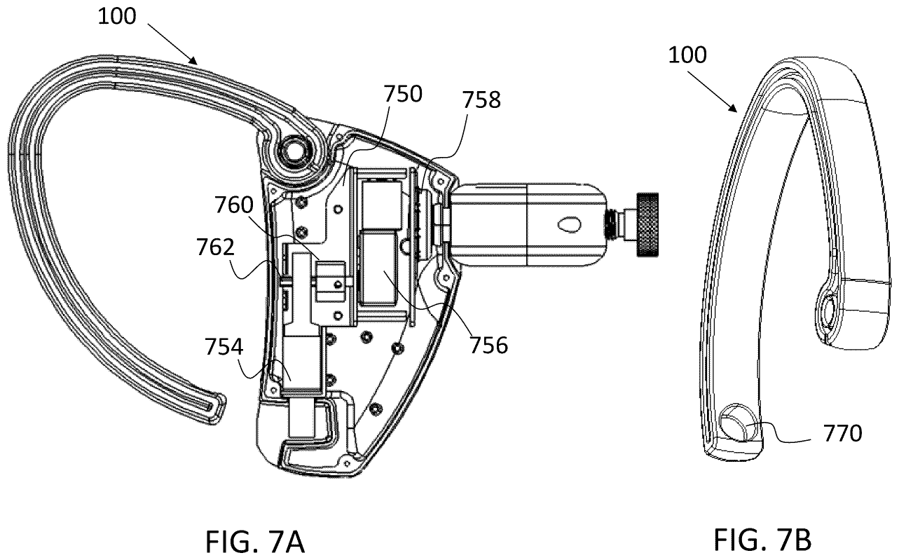

A rotational device such as rotator 112 can be coupled to the bike lock 100 which allows the body 104 to pivot or rotate in a 360-degree angle. This rotational movement allows a bike rider to position the bike lock 100 appropriately by angling the lock arm 102 in a way that traps the bike within the lock area 110 to secure the bike, taking into consideration the bike's design. In some embodiments, rotator 112 can be coupled to the bike lock 100 in between the body 104 and clamp 114. In some embodiments, the rotational device includes a rotary speed limiter such as speed limiter 758 of FIG. 7A. In alternate embodiments, the rotator 112 can be coupled to the body 104 at a different position and/or configuration from FIG. 1 as long as rotator 112 allows the pivot/rotation of the body 104 and consequently the lock arm 102 regardless of its point of coupling to the body 104.

Bike lock 100 further includes grip 118 which is an ergonomic feature designed to improve control, stability, and comfort by providing a textured, contoured, or raised surface for the user (e.g. the user's thumb). As such, grip 118 reduces slippage and enhances precision while locking/unlocking a bicycle.

The lock arm 102 can include any suitable shape or size. For example, lock arm 102 can be U-shaped, C-shaped, etc. It can have curved or straight edges. It can also include multiple components or it can be a single structure. As previously mentioned, the lock arm 102 can swing open to allow a user to place a portion of their bicycle (e.g. bike frame, wheel, etc.) within lock area 110 when the bike lock 100 is unlocked. In some embodiments, the bike lock 100 includes an internal Lock Latch (not shown) to secure the lock arm 102 to the body 104, thereby creating a closed loop where the portion of the bicycle is trapped and secured.

In some embodiments, the internal lock latch can include a custom-built latch designed to fit the dimensions of the bike lock 100. In some other embodiments, the internal lock latch can include any other suitable latch such as a door latch, window latch, etc.

In accordance with the present disclosure, the smart bike lock can include an automated lock system which secures the lock in place. The lock moves between a locked configuration and an unlocked configuration enabling automation and cloud-based technology to the system. In some embodiments, the lock/unlock function can be instigated via a wireless communication technology, electronic buttons, a touchscreen, credit card reader, RFID reader, an electronic keypad on the bike lock device, a web application, or any other means of electronic communication, or mechanical systems, such as, but not limited to, a physical key.

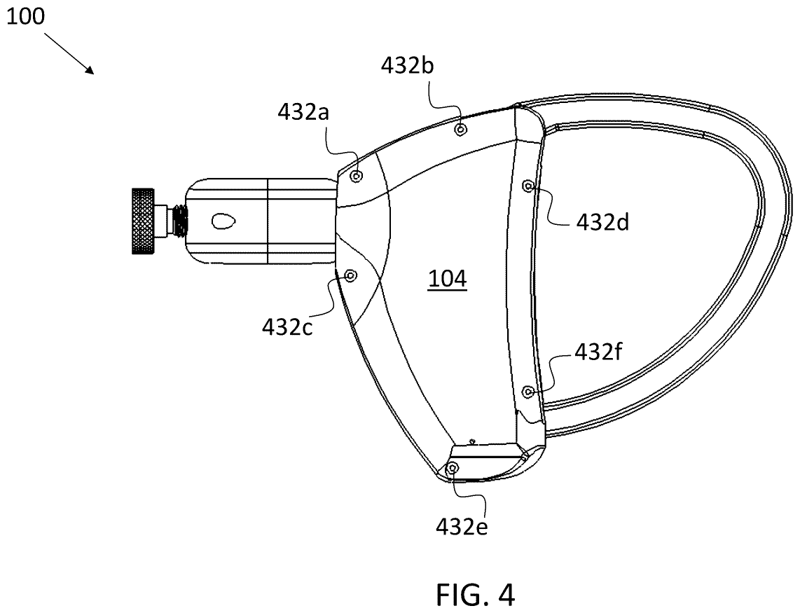

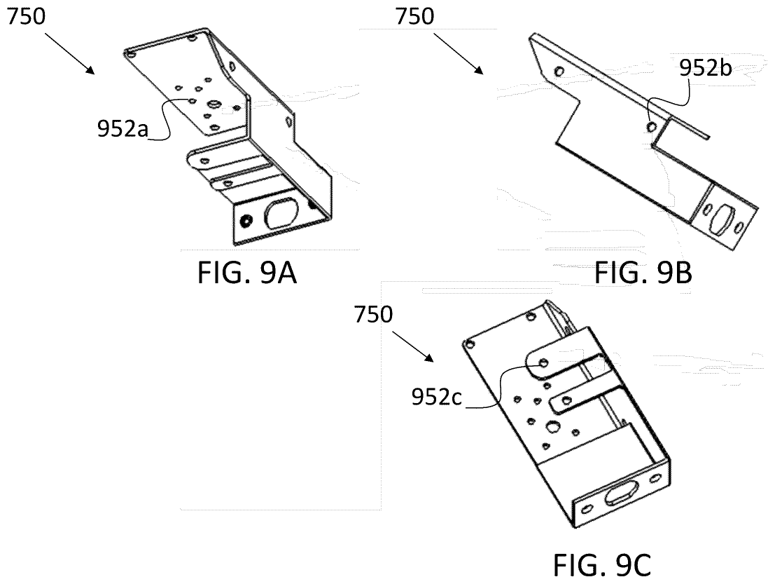

Body 104 acts as a casing with at least two sides to securely enclose its components. As shown in FIG. 4, body 104 includes plurality of screws 432 to hold the two sides of the casing together. In some embodiments, the body 104 can be coupled together with adhesives, fasteners or interlocking components. As shown in FIG. 7A the body 104 includes a mount 750 to integrate the various electrical and hardware components together. As can be seen in FIG. 9A, FIG. 9B and FIG. 9C, in some embodiments, mount 750 can include a bracket that securely holds the locking mechanism in place with the use of fasteners such as a plurality of screws (not shown).

Turning to FIG. 7A, in some embodiments, the components of the locking mechanism can include adapter 760, internal lock latch including deadbolt 754, an actuator including motor 756 and power supply (not shown). In some embodiments, the power supply is an external power supply. In contrast, in other embodiments, the power supply is on-board power source(s) such as batteries, ultra-capacitors or photovoltaic cells.

A plurality of screws (not shown) secures the locking mechanism to mount 750, inserted into a plurality of mounting holes 952. For example, mounting hole 952a facilitates the attachment of motor 756 to mount 750, while mounting hole 952c facilitates the attachment of deadbolt 754 to mount 750 via screws (not shown). The assembled mount 750 along with its components, can be affixed inside body 104 by securing screws at designated points, such as mounting hole 952b.

Once instructions are sent to lock the device, deadbolt 754 is pushed towards the recess 770 (shown in the detail of FIG. 7B) of lock arm 102 using motor 756 coupled to deadbolt 754 via adapter 760 until deadbolt 754 is securely engaged with the lock arm 102. In the release sequence, deadbolt 754 is removed by rotating the motor 756 in the opposite direction until deadbolt 754 is fully disengaged from the lock arm 102.

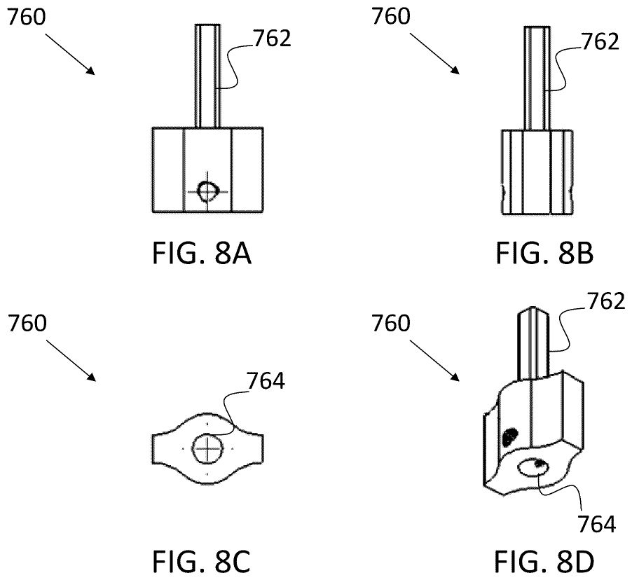

FIG. 8A, FIG. 8B, FIG. 8C and FIG. 8D illustrate adapter 760 viewed in different angles. The screw hole 764 is used to couple spindle 762 to the motor 756 axle. As shown in FIG. 8C and FIG. 8D, screw hole 764 and consequently the output profile of motor 756 is circular. In contrast, as shown in FIG. 8A, FIG. 8B and FIG. 8D the spindle 762 and consequently the output profile of deadbolt 754 is rectangular. In order to convert the circular output profile of motor 756 to the linear motion required for rectangular deadbolt 754, a mechanical linkage or a transmission system is needed. Some embodiments can employ a rack-and-pinion mechanism, a lead screw (e.g. a threaded rod), a cam mechanism or a solenoid and spring system actuator to perform such a conversion.

The adapter 760 coupled to motor 756 is used to control the movement of deadbolt 754. In some embodiments, spindle 762 can be a rotating shaft which transfers the motor's 752 rotational force to move deadbolt 754 linearly.

The lock arm 102 may include a recess towards the distal end of pivot point 106 where the recess aligns with the shape and dimensions of deadbolt 754 in order to insert a portion of deadbolt 754 to the lock arm 102 when lock arm 102 is in a closed position. This allows the secure locking of the bike lock 100. In order to open the lock arm 102, a user may unlock bike lock 100 which releases the deadbolt 754 from lock arm 102. This allows the lock arm 102 to swing open/away from/out of the lock latch point 120.

In some embodiments, a sensor is used to detect whether the deadbolt 754 has properly engaged the lock arm 102, missed it entirely, or only partially engaged as well as to ensure proper locking and unlocking. When the motor 756 drives the deadbolt 754 toward the lock arm 102, it draws a predictable amount of current under normal load. If the internal lock latch including deadbolt 754 fully engages with the lock arm 102, the motor 756 encounters a brief resistance near the end of its travel due to the profile of the lock arm (enclosed at the end), causing a short spike in current (a stall or near-stall condition) before the motor 756 stops. This spike confirms successful engagement.

If the internal lock latch including deadbolt 754 completely misses the lock arm 102, the motor 756 encounters minimal resistance and draws less current throughout its motion, with no characteristic spike.

In the case of a partial engagement, such as the internal lock latch including deadbolt 754 grazing the edge of the lock arm 102, the motor 756 may draw higher-than-normal current for longer durations in the beginning, or produce a noisy or inconsistent current profile. The resistance, current and power data of motor 756 can be monitored to assess which scenario occurred and respond accordingly. In some embodiments, a current and power monitoring sensor, such as INA219 available from Texas Instruments Incorporated can be utilized.

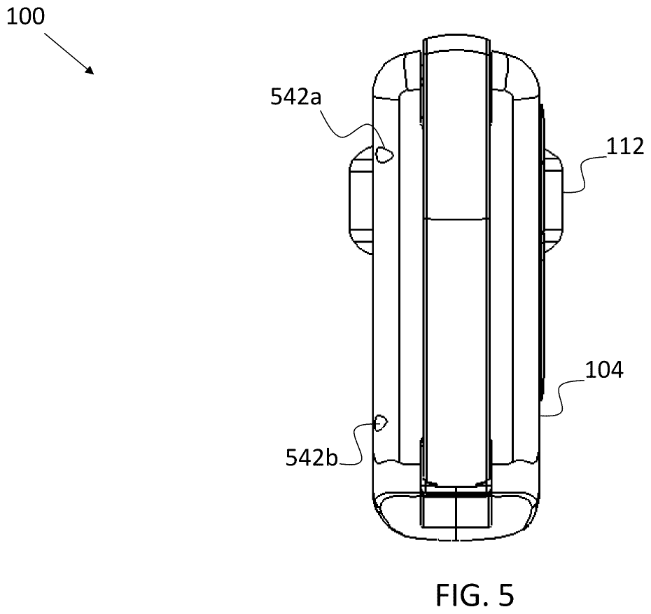

As shown in FIG. 5, in some embodiments, bike lock 100 can be symmetrical from the front. In some embodiments, bike lock 100 can include a notification means such as a plurality of LEDs 542, speakers (not shown), web application notifications etc. to display/indicate the status of the lock.

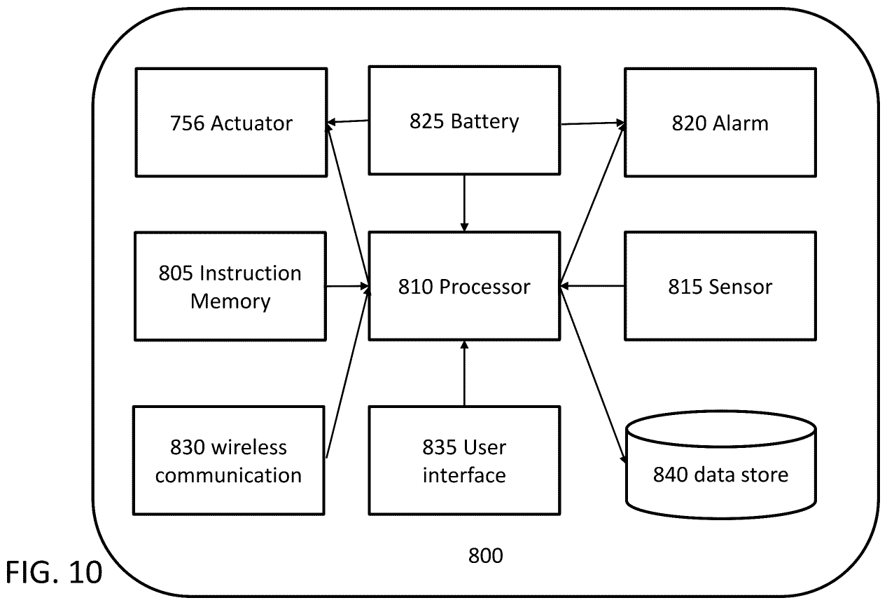

FIG. 10 is a block diagram of components of electric circuit 800 located within the bike lock body. The circuit may include instruction memory 805, battery 825, and processor 810 arranged to communicate with users and control the lock's operation (e.g. actuator 756 for the latch). Commands may be received via wireless communications 830 and/or user interface 835, e.g. buttons, GUI, or touchscreen. The processor receives signals from sensors 815, controls the alarm(s) 820, and stores data about the lock's operation, history, and alarm events at data store 840.

The lock/unlock function can by instigated via a wireless communication technology such as a web-based application, electronic buttons, a touchscreen, an electronic keypad on the bike lock device, credit card reader, RFID reader, any other means of electronic communication, or a mechanical system (e.g. a physical key). The remote Web or Mobile App may be programmed to identify users, authorize users for access, and authorize payments. The bike lock's processor is programmed to receive these wireless communications, decrypts them, and authenticate their requests. The bike lock's processor can confirm or deny the request back to the App.

The processor may be programmed to detect events based on unusual behaviour, without the need for sensors. If a locking subsystem reports multiple unsuccessful lock or unlock attempts by different users in a short period, the processor may trigger an alert to a central monitoring system or local authorities. The App may allow users to set up personalized notifications for unusual activity related to their reserved lock.

The alarm data could be used by the App for predictive maintenance by analyzing patterns in alarm triggers (e.g., frequent false alarms in a specific location) to identify potential issues with the lock hardware or the surrounding environment before they become major problems. This proactive approach saves on maintenance costs and improves user satisfaction. Usage patterns could inform urban planning decisions related to bike infrastructure. Anonymized alarm data could help identify areas with potential security concerns and present or historical usage data provides predictive or real-time bike parking availability.

As shown in FIG. 6A, FIG. 6B and FIG. 6C, the present disclosure provides a smart IoT bicycle/e-bike lock (i.e. bike lock 100) that can be affixed to a wide range of public or private infrastructure (i.e. bike lock station 600) such as sign posts, bike racks, bike stands, horizonal and/or vertical bars or posts. The application of the lock is to remain in one location generally but can slide, rotate, and pivot along several axes, while attached to a given infrastructure. The lock can be accessed via a mobile device or computer using one or multiple IoT communication methods such as, BLE, low powered BLE, cellular, wifi, LoRaWAN, etc.

Furthermore, bike lock 100 can include additional sensors or other anti-theft features that could trigger an alarm to sound within the bike lock 100, as well as send wireless notifications (email, text, app etc.) to individuals such as, but not limited to, users, law enforcement officials, and/or security teams. In some embodiments, the anti-theft feature may include a wire such as alarm wire 108 of FIG. 1 that is embedded within the lock arm 102. If an attempt was made to vandalize bike lock 100 by for example, cutting or sawing the lock arm 102 with an angle grinder, etc., the decoupling of alarm wire 108 can trigger an alarm on site using an internal buzzer, as well as notify the lock's user and local security teams via an IoT wireless hub.

Some embodiments can include sensors such as accelerometers capable of detecting excessive shaking of the bike lock which may also trigger an alarm.

The smart bike lock can utilize a web application, mobile application, and/or other forms of software to communicate and act as an interface for user instructions, Bike Lock operation, Bike Lock user reservations, user and/or stakeholder notifications, recording and exchange of any user or event data, user account management, user or customer payment collection, offering of other products and services, such as but not limited to extended bike insurance.

1. A bike lock, comprising:
a bike lock body;
a bike lock clamp fixable to public infrastructure and arranged to slide, rotate, or pivot thereto;
a locking arm connected to the bike lock body and moveable thereto to receive a bike frame or wheel in an unlocked configuration;
a lock latch that secures the locking arm to the bike lock body in a locked configuration, whereby the bike frame or wheel is secured; and
an electronic circuit to receive a lock/unlock command from a user and relay a signal to lock the lock latch.

2. The bike lock of claim 1, wherein the locking arm is connected to the bike lock body at a pivot point at an end of the locking arm opposite from the lock latch.

3. The bike lock of claim 1, further comprising an anti-theft sensor, preferably located within the locking arm, more preferably as an alarm wire providing electrical continuity to and from the bike lock body, when the bike lock is in the locked configuration.

4. The bike lock of claim 1, further comprising an actuator that moves the lock latch upon receiving the signal from the electronic circuit.

5. The bike lock of claim 1, wherein the electronic circuit receives the lock/unlock command by at least one of: wireless communication, electronic buttons, a touchscreen, credit card reader, RFID reader, or an electronic keypad.

6. The bike lock of claim 1, further comprising sensors to trigger an alarm and send wireless notifications.

7. The bike lock of claim 1, further comprising a tightener to tighten or loosen the bike lock clamp on the infrastructure.

8. The bike lock of claim 1, the electronic circuit comprising a processor and instruction memory arranged to interface with a remote application to communicate and act as an interface for user instructions, bike lock operation, bike lock user reservations, stakeholder notifications, recording and exchange of user or event data, user account management, or customer payment collection.

9. A method of operating a bike lock, having a bike lock clamp, locking arm, and electronic circuit, the method comprising:
fixing a bike lock clamp to public infrastructure;
opening a locking arm connected to the bike lock body in an unlocked configuration and receiving a bike frame or wheel;
closing the locking arm into a locked configuration to secure the bike frame or wheel;
receiving a lock/unlock command from a user, at an electronic circuit within the bike lock; and
relaying a signal to secure the locking arm to the bike lock body with a lock latch in the locked configuration.

10. The method of claim 9, further comprising powering an actuator to move the lock latch upon receiving the signal.

11. The method of claim 9, wherein the lock/unlock command is received by at least one of: wireless communication, electronic buttons, a touchscreen, credit card reader, RFID reader, or an electronic keypad.

12. The method of claim 9, further comprising detecting a security event by sensors and then triggering an alarm and sending wireless notifications.

13. The method of claim 9, tightening the bike lock clamp on the infrastructure.

14. The method of claim 9, the electronic circuit comprising a processor and instruction memory to interface with a remote application to communicate and act as an interface for user instructions, bike lock operation, bike lock user reservations, stakeholder notifications, recording and exchange of user or event data, user account management, or customer payment collection.
